(19) United States
(12) Patent Application Publication
(10) Pub. No.: US 2015/0136311 A1
(43) Pub. Date: May 21, 2015

(54) Fillable Stencil Pattern

(71) Applicant: Olaf Mjelde, Ventura, CA (US)

(72) Inventor: Olaf Mjelde, Ventura, CA (US)

(21) Appl. No.: 14/542,482

(22) Filed: Nov. 14, 2014

Related U.S. Application Data
(60) Provisional application No. 61/905,091, filed on Nov. 15, 2013.

(51) Int. Cl. B28B 1/14; E04H 4/14; B28B 1/00; B28B 7/00; B28B 11/22

(52) U.S. Cl. CPC B28B 1/14; B28B 7/0029; B28B 11/22; B28B 1/008; E04H 4/14
USPC 156/245; 249/83

(57) ABSTRACT

A pool stencil pattern includes a frame anchoring hard curing decorative material in a swimming pool plaster coat. The frame includes a perimeter wall with an exterior surface and interior surface, both having ridges near their centerlines. The frame also includes interior walls circumscribed by the perimeter wall defining compartments for different hard curing decorative materials. The interior walls also have opposing ridges near the centerline. The ridges hold cured decorative material in the stencil frame. The perimeter wall and the interior walls are the thickness of the plaster coat making the finished decoration flush with the surface of the swimming pool.

This application claims the benefit of the priority filing date of U.S. provisional application No. 61/905,091, filed on Nov. 15, 2013.

### BACKGROUND

Underwater decorations for the sides and bottom surfaces of swimming pools are known in the art. Typically limited to painted indicia on the pool's plaster surfaces, such decorations are disfavored because the paint tends to fade over time, and may peel away from the plaster surface if installed on an improperly prepared surface or improperly sealed.

Another conventional decoration involves tiling pool surfaces. Glass or glazed ceramic tiles are common, and frequently mosaic tiles are used to create patterns or images. Although tiles present an attractive surface decoration, they are expensive, difficult and time consuming to install, particularly when preparing mosaics or intricate patterns, and even properly mortared tiles often dislodge over time.

Other decorative materials for plaster pools include pebble aggregates, glass bead aggregates, or similar plaster substitutes with materials embedded therein. While aggregate presents a relatively resilient surface compared to paint or tile, the material cannot be used to make intricate designs and creating a clean junction between an aggregate and an adjoining plaster surface is difficult.

Several plaster pattern and template apparatus have been developed in the art. One method uses a template for applying relief plastering to a surface. A network of lands made of moisture-resistant material and corresponding to a pattern is applied to a surface using an adhesive layer on one side of the template. After plaster is applied to the surface, the network is removed to reveal join-like depressions in the surface. This technique is disfavored since it requires multiple steps, including removal of the template. It is also disfavored for swimming pools because a no barrier exists between the decorative pattern and the pool plaster, resulting in the plaster contaminating the decorative material.

Another decorating method useful for exterior surfaces, such as pavement, involves forming a simulated pavement pattern using a stencil. The stencil is formed into a roll and a continuous length of stencil is unwound from the roll. The stencil is adhered to the surface, then composition is adhered to the substrate through apertures of the stencil. This method is disfavored because it requires adhesive and the use of a release agent, which would remove an barrier between the decorative patter and surrounding pool plaster.

Another manner of customizing plaster involves forming the plaster in a temporary adhesion template. As plaster paste is applied through cut-outs in the to template it adheres to a substrate. Subsequently the template is removed. The template includes a marginal portion and pattern elements connected to the a marginal portion. This apparatus is disfavored since the pattern contemplates a thin paper which may be torn when pressed into thin-set mortar and is incapable of confining a coarse decorative material, such as aggregate used in swimming pools.

Due to the aforementioned deficiencies in the art, it is an object of the present invention to provide a resilient stencil having a decorative shape and adapted for adhesion to pool thin-set mortar. Another object of the preset invention is to provide a barrier between the decorative material applied to the stencil and pool plaster. Another object is to provide a stencil capable of supporting three dimensional decorative materials such as pebble aggregate and glass bead decorations among others.

### SUMMARY

A stencil pattern includes stencil frame for anchoring hard curing decorative material in a plaster coat of a swimming pool includes a perimeter wall having an exterior surface and an opposing interior surface. The exterior surface includes a first ridge near the center of the exterior surface, the first ridge extending longitudinally around a substantial length of the perimeter wall for anchoring the stencil frame in the plaster coat. The interior surface has a second ridge near the center of the interior surface extending longitudinally around a substantial portion of the interior surface for anchoring the hard curing decorative material in the stencil frame.

The stencil frame also includes one or more interior walls extending between the perimeter wall defining compartments in the stencil frame for placing multiple types of the hard curing decorative material in the compartments. The interior walls have third and fourth ridges near the center of opposing sides of the interior walls. The third and fourth ridges extend longitudinally along a substantial length of the interior walls for anchoring the hard curing decorative material in the stencil frame.

Preferably, the perimeter wall of the stencil frame has a height that is approximately the thickness of the plaster coat. In one embodiment, the stencil frame's interior walls may be substantially thinner than the perimeter wall. In an alternative embodiment the stencil frame may include one or more a bridge members coupling the stencil frame to a secondary stencil frame.

The stencil pattern may also be characterized as a stencil for decorating a swimming pool, having a stencil frame forming a substantially two dimensional outline. The stencil frame includes a perimeter wall of a predetermined a height. The perimeter wall has two substantially linear opposing sides, and each opposing side is approximately bisected by a ridged area extending around the stencil frame. The ridged area presents a first raised profile for holding a hard curing decorative material in the stencil frame, while wherein the ridged area also presents a second raised profile for holding the stencil frame in a plaster coated surface of the swimming pool. The perimeter wall may also include branching inner walls circumscribed by the perimeter wall, thereby creating individual compartments in the stencil frame.

The stencil pattern presents a method of decorating the surface of a pool, including providing a substantially two dimensional stencil frame having walls with ridges extending around a middle portion of the walls. The stencil frame is filed with a liquid phase hard curing decorative material which is allowed to cure, thereby anchoring the decorative material on the ridges of the stencil frame. The stencil frame is then affixed to an uncured shotcrete surface in a swimming pool.

Once the shotcrete is allowed to cure, and the pool is plastered, including the area around the stencil frame, then the plaster is allowed to cures. In some cases, multiple hard curing decorative materials having different characteristics may be added into separate individual compartments of the stencil frame. After the plaster cures, the plaster, the stencil frame, and the decorative material may be acid washed according to convention. In this manner, a decorative pattern of hard cured decorative material can be easily embedded in any of the pool's plastered surfaces.

### BRIEF DESCRIPTION OF THE FIGURES

FIG. 1 is a top view of a frame for a pool decoration having individual panes in the frame.

FIG. 2 is a cross section of a perimeter wall of the frame.

FIG. 3 is a cross section of an inner wall of the frame.

FIG. 4 is an enlarged view of individual panes of the frame containing different decorative materials.

FIG. 5 is to plan view of the frame having panes individually filled with various decorative materials.

FIG. 6 is a plan view of a first alternative embodiment frame having secondary frames connected by bridge members.

FIG. 7 is a plan view of a second alternative embodiment stencil pattern embedded in pool plaster.

FIG. 8 is a perspective view of a non-aquatic installation of the frame

### REFERENCE NUMBERS

10. stencil frame

12. perimeter wall

14. exterior surface

16. interior surface

18. first ridge

20. second ridge

22. interior wall

24. compartment

26. first opposing side

28. second opposing side

30. third ridge

32. fourth ridge

34. decorative material

36. second decorative material

38. tortoise fins

40. tortoise shell

100. first alternative embodiment frame

102. secondary frame

104. main body portion

106. bridge member

200. second alternative embodiment frame

202. pool plaster coat

300. third alternative embodiment frame

302. wear layer

304. compartment

306. second wear layer

308. third wear layer

### DESCRIPTION

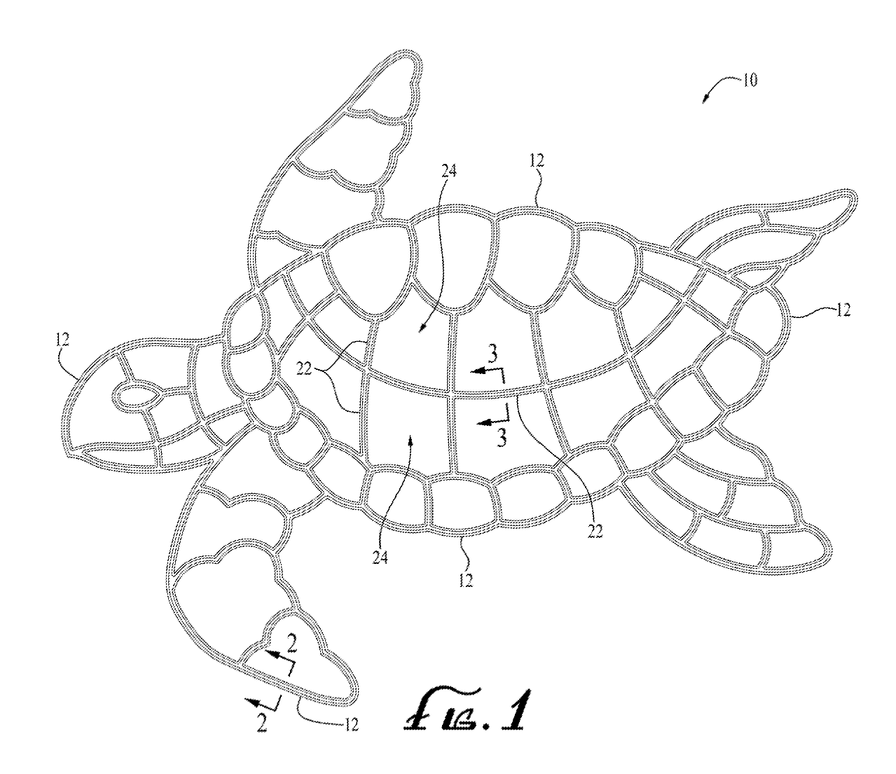

Referring to FIG. 1, a stencil for decorating the surfaces (i.e., the sides or bottom) of a swimming pool (not shown), comprises a stencil frame 10. The stencil frame 10 includes a contiguous perimeter wall 12, forming the perimeter and overall shape of the stencil frame 10, and one or more interior walls 26 forming interior patterns in the stencil frame 10. Multiple interior walls 26 are preferably interconnected, forming a contiguous network of interior walls 26, such that a particular shape formed by the network of interior walls 26 represents intricate details of an image (in the exemplary embodiment, a sea tortoise) to show it in greater relief and resolution. While the exemplary stencil frame 10 depicts a sea tortoise, the stencil frame 10 may be rendered in virtually any image, preferably in the style of a line drawing.

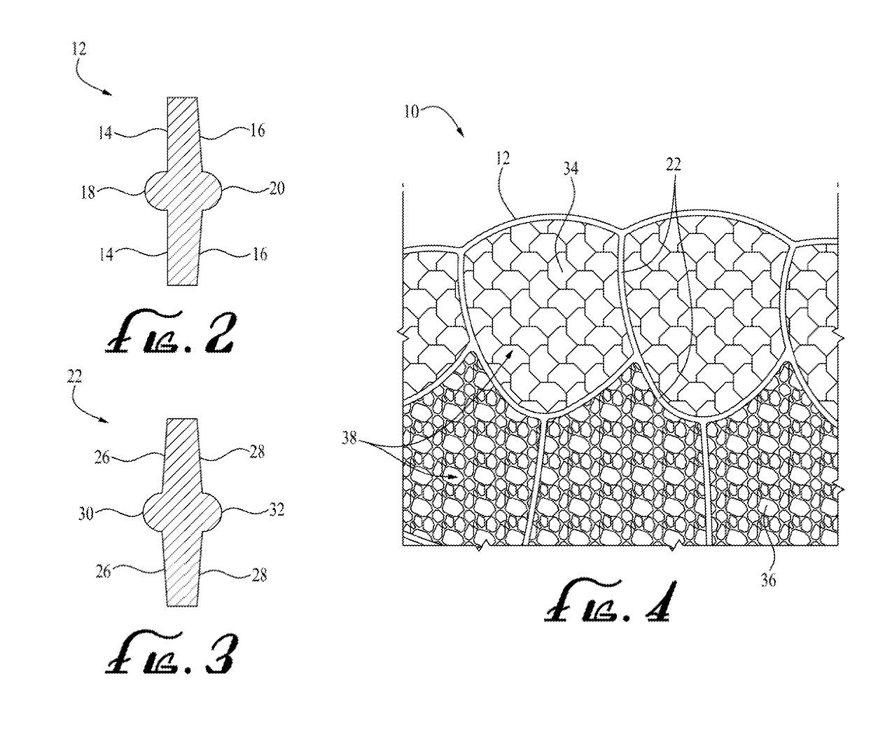

Referring to FIGS. 1 and 2, the perimeter wall 12 of the stencil frame 10 is designed specifically to interface with a decorative material 34 (shown in figures four and five) such as cement aggregate incorporating glass bead, pebble, etc., and also designed to interface with conventional pool plaster 202 (not shown). To accomplish this, the perimeter wall 12 includes an exterior surface 14 forming the exterior of the stencil frame 10, and an interior surface 16 forming the inward-facing perimeter of the stencil frame 10.

The exterior surface 14 has a first ridge 18 located near a horizontal centerline of the exterior surface 14 and extending longitudinally around at least a substantial length of the perimeter wall 12 in order to anchor the stencil frame 10 in the swimming pool plaster coat when installed. This way, the stencil frame 10 is reversible according to preference. Similarly, the interior surface 16 includes a second ridge 20 located near a horizontal centerline of the interior surface 16 and extending longitudinally around at least a substantial length of the perimeter wall 12 in order to anchor the decorative material 34 in the stencil frame (10) when installed.

Although the illustrated embodiment shows the first ridge 18 formed as a rounded bulge, alternative embodiments contemplate a first ridge 18 of virtually any profile (e.g., square, triangular, trapezoidal, etc.), or even multiple ridges. Preferably, the first ridge 18 extends outward approximately 0.05 inches in order to effectively engage the swimming pool plaster 202 (not shown). One contemplated width of the first ridge 18 is approximately 0.1 inch, although different profiles and different sizes may be used to optimize the stencil frame (10) engaging the pool plaster 202. The second ridge 20 is also shown as a rounded bulge, but the second ridge 20, like the first ridge 18, may have be of virtually any profile (e.g., square, triangular, trapezoidal, etc.), or even multiple ridges. The second ridge 20 also preferably extends outward approximately 0.05 inches with a width of approximately 0.1 inch.

The exterior surface 14 is preferably substantially perpendicular to the first ridge 18, with portions of the exterior surface 14 on either side of the first ridge 18. In one embodiment, the exterior surface 14 may extend approximately 0.2 inches on either side of the first ridge 18. Consequently, the perimeter wall 12 will be half (0.5) an inch wide. This is the standard thickness of plaster coats of conventional swimming pools. Thus, when installed, the stencil frame 10 will be flush with the pool surface into which the stencil frame 10 is embedded. Ideally, the first ridge 18 will be centered on the exterior surface 18, making the stencil frame 10 reversible.

In the illustrated embodiment, while both the exterior surface 14 and the interior surface 16 are oriented substantially perpendicular to the first ridge 18 and the second ridge 20, respectively, the interior surface 16 is shown having a slight angle, such that the interior surface 16 creates a gently declining thickness in the perimeter wall from the first ridge 18 and the second ridge 20 outward. In one embodiment, a slope of lour degrees relative to planar is contemplated. By providing a sloping profile, decorative material 34 is encouraged to remain in place within the stencil frame 10. Importantly, in alternative embodiments, the exterior surface 14 and the interior surface 16 may be strictly planar or angled (i.e., sloped) according to preference and manufacturing considerations.

Referring to FIGS. 1 and 3, the stencil frame 10 also includes one or more interior walls 22 extending between the interior surface 16 of the perimeter wall 12. The interior walls 22 form compartments 24 in the stencil frame 10 enabling users to till the stencil frame 10 with multiple types of decorative material 34 having a variety of appearances. The interior walls 22 preferably each have a first opposing side 26 and a second opposing side 28. A third ridge 30 is located near a horizontal centerline of the first opposing side 26, and a fourth ridge 32 is located near a horizontal centerline of the second opposing side 28. Similar to the first ridge 18 and second ridge 20, the third ridge 30 and fourth ridge 32 preferably extend longitudinally along a substantial length of the interior walls 22 for anchoring the decorative material 34 in the compartments 24 for hard curing.

As with the first ridge 18 and second ridge 20, the third ridge 30 and fourth ridge 32 are shown as bulges extending 0.05 inches from the interior wall 22, but may be any of a variety of profiles according to preference and effectiveness. Like the first ridge 18 and second ridge 20, the third ridge 30 and fourth ridge 32 are preferably approximately 0.1 inch in width, extending approximately 0.05 inches from the interior walls 22. Also like the perimeter wall 12, the interior walls 22 may extend approximately 0.2 inches on either side of the third ridge 30 and fourth ridge 40, which are 0.1 inches wide, making the interior walls 22 the same height as the perimeter wall 12, and the stencil frame 10 the same thickness overall.

As shown, the interior walls 22 may be angled, similar to the interior surface 16 (FIG. 2) of the perimeter wall 12, including four degrees relative to planar, although other angles are contemplated according to preference. By having the first opposing site 26 and the second opposing side 28 of the interior walls 14 angled, decorative material 34 will be more securely anchored in place as mentioned above. Additionally, such a con figuration produces a slightly reduced interior wall 14 thickness relative to the perimeter wall 12, thereby creating an aesthetically pleasing appearance with the perimeter wall 12 standing out more than the interior walls 22 in some embodiments.

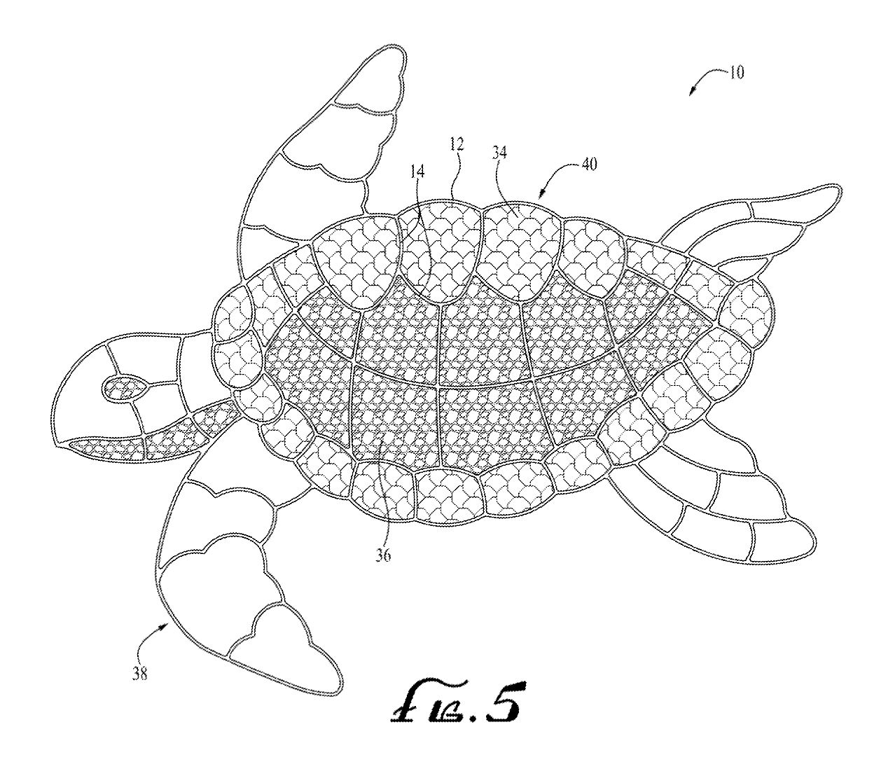

Referring to FIG. 4 a decorative material 34 and a contrasting second decorative material 36 is shown installed in the stencil frame 10. The perimeter wall 12 together with the interior walls 22 form differently shaped compartments 24 for bolding the decorative material 34 and the second decorative material 36 (and third, fourth, etc. decorative materials not shown) in a desired location. To enhance the visual effectiveness and aesthetic appearance of a stencil frame 10 installed in a pool, materials having different colors or textures may be placed in individual compartments 24. Although pebble aggregate is exemplary, other aggregates such as glass bead, or other materials having resilient stone-like properties may be used. In some instances a uniform material such as plaster, including using different colored plaster in different compartments 24, may be used. In some instances the compartments 24, if small, such as representing an eye or spot, may be pre-filled.

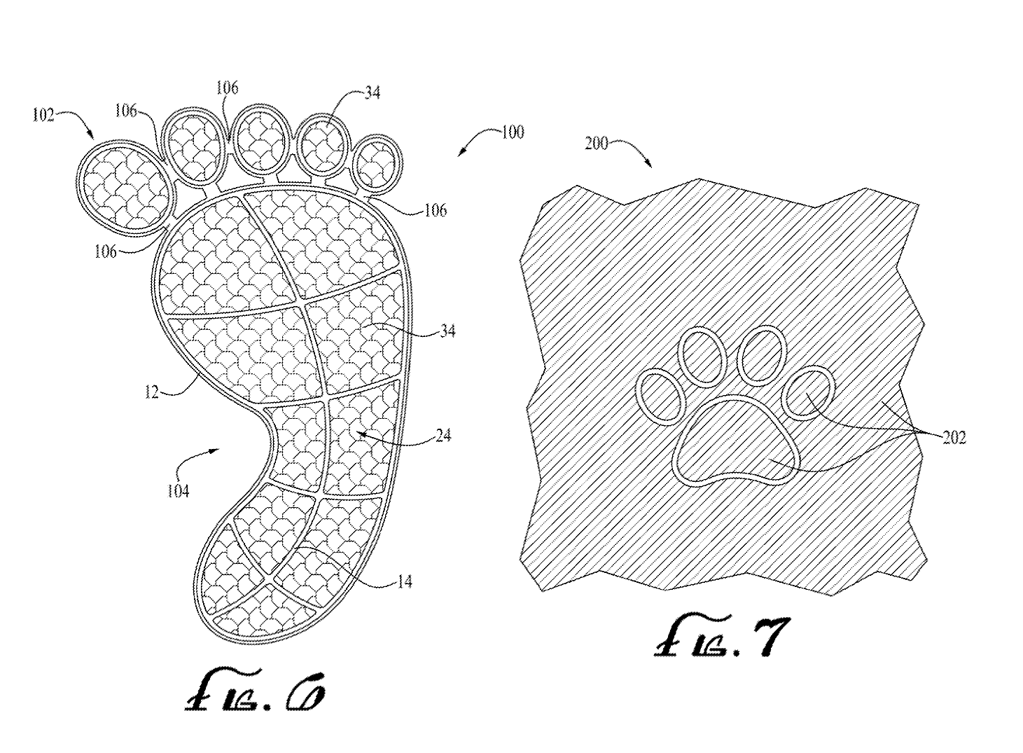

Referring to FIG. 5, an entire stencil frame 10 representing a sea tortoise is shown partially filled with the decorative material 34 along with a second decorative material 36. In this view, compartments 24 of the stencil frame 10 corresponding to the tortoise's fins 38 are shown contrasting with the compartments 24 of the stencil frame 10 corresponding to the tortoise's shell 40. Additionally, the compartments 24 on the tortoise shell 40 interior are filled with the second decorative material 36 for contrast. When the stencil frame 10 is filled with decorative material 34, and optionally the second decorative material 36 (and others), it may be installed in a swimming pool and surrounded with conventional pool plaster 202 (not shown) to embed the filled stencil frame 10 in the sides, bottom, or other plastered surfaces of the pool.

Referring to FIG. 6, a first alternative embodiment stencil frame 100 is shown in the shape of a footprint. In this example, some of the decorative material 34 is located in one or more secondary frames 102, or “islands” separated from the main body portion 104 of the stencil frame 100. A series of bridge members 106 connects the secondary frames 102 to the main body portion 104, extending from the first ridge 18 to ensure uniform ridging while keeping the bridge members 106 out of view when the stencil frame 100 is installed. The other portions of the stencil frame 100, including the perimeter wall 12 and interior walls 14, and their respective characteristics remain as discussed above.

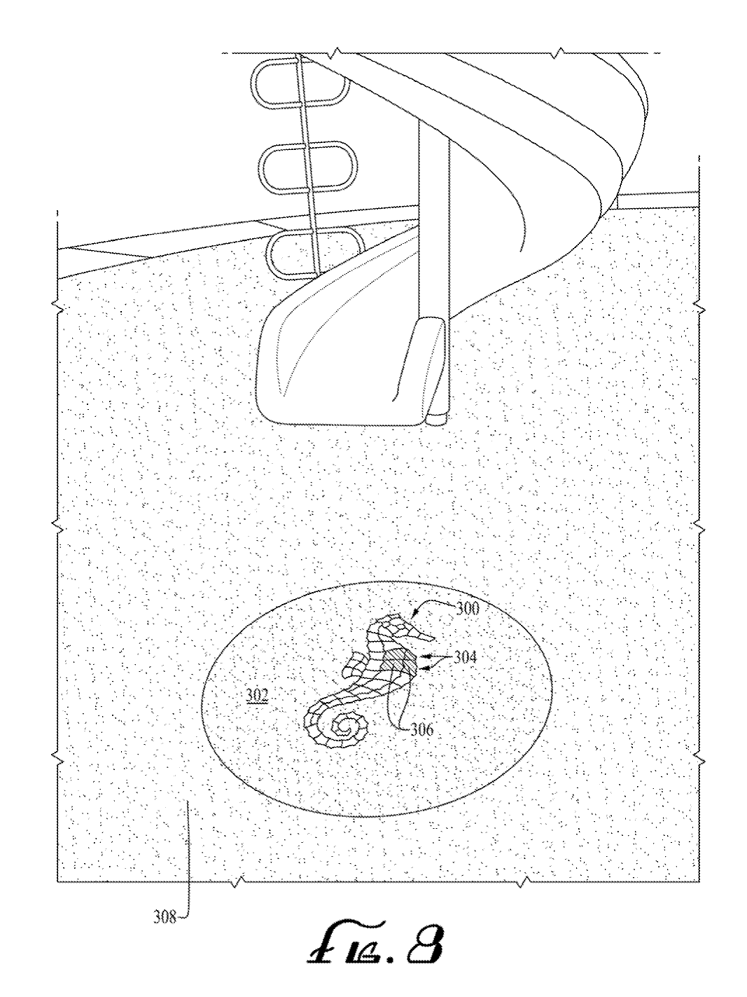

Referring to FIG. 7, a second alternative embodiment stencil frame 200 is shown in the form of a paw print. This stencil frame 200 shows an alternative installation technique wherein the stencil frame 200 is filled with the same pool plaster coat 202 surrounding it. In this instance, the stencil frame 200 serves as a decoration in and of itself. Used in this manner, the stencil frame 200 can provide a more subtle appearance when installed. In the event a conventional white pool plaster is used, a colored stencil frame 200 may be used to show contrast. Additionally, this technique may be employed using all other embodiments of the stencil frame 200 discussed herein.

Referring to FIG. 8, a third alternative embodiment of the stencil frame 300 is shown. In this embodiment, the frame 300 is installed in a playground. Modern playground safety surfacing (also used in other areas where protective ground cover is desired), is wet-poured and typically made from granules of recycled rubber to create a cushioning, non-abrasive ground cover. The surfacing includes a thick base layer (not shown) topped with a wear layer 302. While the both the base layer and the wear layer 302 are made of recycled rubber, the wear layer 302 may use smaller pellets, is frequently colored, and may be shaped into decorative patterns.

Currently, the only way to introduce patterns in a wear layer 302 is to form, pour, and dry them ahead of time. Then, once the base layer is installed and dried, the forms are placed on the base layer, and the wear layer 302 installed around the forms. Using the stencil frame 300, several of these steps are avoided, saving time. After the base layer is installed, a stencil may be placed directly on the base layer and differently colored wear layer 302 materials poured in place.

The improved process has the added advantage, that small, intricate patterns can be seated without the risk of separately poured shapes moving out of alignment during installation. In the illustrated embodiment, a hybrid of the traditional installation technique and a stencil frame 300 installation is used. The stencil frame 300 is placed in a large circular mold (not shown), then each compartment 304 of the stencil frame 300 is filled With a second wear layer 306 of a desired color. Without having to wait for the second wear layer 306 to dry, as third wear layer 308 may be poured around the stencil 300. The stencil 300 and third wear layer 308 may then be placed in position on the base layer. Alternatively, if no separate second layer 306 and third layer 308 were needed the stencil could be placed directly on the base layer, and its surroundings filled with the second wear layer 306 when poured across the area.

Although wet-pour rubber safety surfacing is illustrated, and an exemplary embodiment, the stencil 300 may be used in any installation having an underlying backing surface to be covered with a secondary finishing surface, such as terrazzo flooring, patterned wall murals, etc. Preferably, the stencil 300 is made of an adhesion facilitating vinyl and all embodiments of the stencil (10/100/200/300) may be made of glow-in-the-dark material, in addition to any desired color.

The overall structure of the stencil frame having been shown and explained, its method of manufacture and use will now be discussed.

Typically, the layout of each stencil frame 10 is initially created using computer-aided design (CAD) or similar software. With the design created, including the stencil frame's 10 shape and sub-features (i.e., the interior walls 22, first ridge 18, second ridge 20, etc.), the stencil frame 10 may be easily manufactured using an injection molding technique. Other forming methods such as 3D printing and machining are also contemplated according to preference and economy. Because the stencil frame 10 must withstand harsh chemicals during installation in addition to prolonged exposure to pool water, the stencil frame 10 is preferably made of an ABS (acrylonitrile butadiene styrene) or similar resilient plastic material. ABS is favored because it has a small degree of flexibility to avoid being brittle, yet is resilient enough to maintain the shape of the stencil frame 10 pattern when heavy plaster or aggregate materials are pressed into it.

To use the stencil frame 10, a preferable location is selected according to the shape and design of a swimming pool. The stencil is filled with a desired decorative material 34 and allowed to cure. Once the bottom and sides of the pool have been formed, typically using shotcrete or gunite, the filled stencil frame 10 is placed in position. Alternatively, in cases where the stencil frame 10 is to be used without decorative material 34, as illustrated in FIG. 7, it may be simply pressed into position in the still-soft sides or bottom of the pool. For vertical surface installations, an adhesive or glue may be used to help hold the stencil frame 10 in position as needed.

Once the stencil frame 10 is affixed in place and the shotcrete has dried, the swimming pool may be plastered according to convention, including plastering around the stencil frame 10. The stencil frame 10 may be covered with construction paper or a similar removable material for protection. Any excess plaster remaining on the surface of the stencil after plastering is scraped away. Since swimming pool plaster is typically 0.5 inches in thickness, with the plaster installed around the stencil frame 10, the stencil frame 10 will be flush with the side, bottom, or other surface of the pool. After plastering, before filling the swimming pool, the surfaces including the tilled stencil frame 10 may also be acid washed to help expose more of the aggregate material, giving the stencil frame 10 and its surroundings a clean appearance.

While the apparatus and method have been described in detail with reference to specific embodiments thereof, it will be apparent to one skilled in the art that various changes and modifications can be made therein without departing from the spirit and scope thereof. Thus, it is intended that the present description cover the modifications and variations of the apparatus and method provided they come within the scope of the appended claims and their equivalents.

What is claimed is:

1. A stencil frame for anchoring hard curing decorative material in a plaster coat of a swimming pool, the stencil frame comprising:
a perimeter wall having an exterior surface and an opposing interior surface;
the exterior surface having a first ridge proximate the center of the exterior surface and extending longitudinally around a substantial length of the perimeter wall for anchoring the stencil frame in the plaster coat; and
the interior surface having a second ridge proximate the center of the interior surface extending longitudinally around a substantial portion of the interior surface for anchoring the hard curing decorative material in the stencil frame.

2. The stencil frame of claim 1 further comprising one or more interior walls extending between the perimeter wall defining compartments in the stencil frame for multiple types of the hard curing decorative material, the interior walls having third and fourth ridges proximate the center of opposing sides of the interior walls and extending longitudinally along a substantial length of the interior walls for anchoring the hard curing decorative material.

3. The stencil frame of claim 1 wherein the height of the perimeter wall is approximately the thickness of the plaster coat.

4. The stencil frame of claim 1 wherein the interior walls are substantially thinner than the perimeter wall.

5. The stencil frame of claim 1 further comprising a bridge member coupling the stencil frame to a secondary frame.

6. A stencil for decorating a curable surface, comprising:
a stencil frame forming a substantially two dimensional outline;
the stencil frame having a perimeter wail defining a height;
the perimeter wall having two substantially linear opposing sides, each opposing side approximately bisected by a ridged area extending around the stencil frame;
wherein the ridged area presents a first raised profile for holding a curing decorative material in the stencil frame; and
wherein the ridged area presents a second raised profile for holding the stencil frame in the curable surface when cured.

7. The stencil of claim 6 wherein the perimeter wall includes branching inner walls circumscribed by the perimeter wall, thereby creating individual compartments in the stencil frame.

8. A method of decorating a surface, comprising the steps of:
providing a substantially two dimensional stencil frame having walls with ridges extending around a middle portion of the walls;
filling the stencil frame with a liquid phase decorative material;
allowing the liquid phase decorative material to cure thereby anchoring the decorative material on the ridges;
positioning the stencil frame in a preferred location on the surface;
filling the area around the stencil frame with a curable material;
making the curable material substantially the same thickness as the decorative material; and
allowing the curable material to cure thereby anchoring the stencil frame.

9. The method of claim 8 further comprising the step of affixing the stencil frame to uncured shotcrete.

10. The method of claim 8 further comprising the step of acid washing the curable material, the stencil frame and the decorative material.

12. The method of claim 8 including the step of filling multiple compartments in the frame with multiple types of liquid phase decorative material.
